(19) United States
(12) Patent Application Publication
(10) Pub. No.: US 2025/0154878 A1
(43) Pub. Date: May 15, 2025

(54) NOSE CONE HEAT EXCHANGER COOLING AIRFLOW ON OPEN-ROTOR GAS TURBINE ENGINE

(71) Applicant: RTX Corporation, Farmington, CT (US)

(72) Inventor: William K. Ackermann, East Hartford, CT (US)

(21) Appl. No.: 18/935,978

(22) Filed: Nov. 4, 2024

Related U.S. Application Data
(60) Provisional application No. 63/597,437, filed on Nov. 9, 2023.

(51) Int. Cl. F01D 25/12; F01D 5/18; F02C 7/18

(52) U.S. Cl. CPC F01D 25/12; F01D 5/18; F02C 7/185; F05D 2220/32; F05D 2240/30; F05D 2260/213

(57) ABSTRACT

A gas turbine engine includes a rotor having a plurality of blades without an outer housing, and rotating with a nose cone. The rotor, plurality of blades and nose cone provide a rotating structure. A static heat exchanger is positioned within the nose cone and a system for using a working fluid. An inlet from the system is connected to the heat exchanger and an outlet from the heat exchanger is connected back to the system. A central opening is in a central portion of the nose cone to deliver cooling air across the heat exchanger. A duct downstream of the heat exchanger directs the cooling air such that the cooling air can move radially outwardly through the rotating structure such that the cooling air can be directed into a propulsion airflow path. A method and a heat exchange system are also disclosed.

### CROSS-REFERENCE TO RELATED APPLICATIONS

This application claims the benefit of U.S. Provisional Patent Application No. 63/597,437 filed Nov. 9, 2023; the disclosure of which is incorporated by reference in its entirety herein.

### BACKGROUND OF THE INVENTION

This application relates to a gas turbine engine having an open rotor propulsor and a heat exchanger in a nose cone.

Gas turbines are known, and typically include a propulsor delivering air as propulsion external to a core engine, and also delivering air into the core engine. The air in the core engine passes into a compressor section. Compressed air is delivered into a combustor where it is mixed with fuel and ignited. Products of this combustion pass downstream over turbine rotors, driving them to rotate.

It is known that there are accessory systems associated with gas turbine engines. As an example, a lubrication system and cooling air systems are typically required. It is also known that the working fluid of those systems becomes hot and it is desirable to provide a heat exchanger to cool the working fluid.

One type of turbine engine utilizes a ducted fan (e.g., turbofan). A fan is provided with an outer housing, and thus the propulsion air flows into a bypass duct defined by the outer housing and an inner housing. This bypass air may be a source of cooling air for a heat exchanger because the housing allows the associated airflow to have a static pressure above ambient (i.e. pressurized).

However, another type of gas turbine engine utilizes an open rotor propulsor and, with such a system, obtaining cooling air can be a challenge because the lack of a housing forces the associated flow to have a static pressure close to ambient (i.e. un-pressurized).

### SUMMARY OF THE INVENTION

In a featured embodiment, a gas turbine engine includes a rotor having a plurality of blades without an outer housing, and rotating with a nose cone. The rotor, plurality of blades and nose cone provide a rotating structure. A static heat exchanger is positioned within the nose cone and a system for using a working fluid. An inlet from the system is connected to the heat exchanger and an outlet from the heat exchanger is connected back to the system. A central opening is in a central portion of the nose cone to deliver cooling air across the heat exchanger. A duct downstream of the heat exchanger directs the cooling air such that the cooling air can move radially outwardly through the rotating structure such that the cooling air can be directed into a propulsion airflow path.

In another embodiment according to the previous embodiment, the central opening in the nose cone directs air into a diffuser.

In another embodiment according to any of the previous embodiments, further includes an exit manifold downstream of the heat exchanger.

In another embodiment according to any of the previous embodiments, downstream of the exit manifold the cooling air is connected into a connecting duct which turns it in a radially outward direction.

In another embodiment according to any of the previous embodiments, the cooling air is directed radially outwardly into the plurality of blades, and outwardly through at least one blade opening.

In another embodiment according to any of the previous embodiments, further includes an outer housing substantially surrounding at least a portion of a core engine. The outer housing has an axially forwardmost point, and the at least one blade opening is positioned to be radially outward of the axially forwardmost point.

In another embodiment according to any of the previous embodiments, the plurality of blades rotate in a first direction, and each blade of the plurality of blades has a pressure side and a suction side and the at least one blade opening extends out of its respective blade through the suction side such that it directs air generally in a direction opposite to the first direction.

In another embodiment according to any of the previous embodiments, further includes a door operable to selectively block airflow into the central opening in a closed position, or allow airflow into the central opening in an open position.

In another embodiment according to any of the previous embodiments, further includes an actuator for the door.

In another embodiment according to any of the previous embodiments, the heat exchanger is one of rectangular, circular, arc-shaped, or cylindrical.

In another embodiment according to any of the previous embodiments, the cooling air is directed radially outwardly through the nose cone.

In another featured embodiment, a method of operating a gas turbine engine includes the steps of 1) driving a gas turbine engine to rotate a rotor and a nose cone, the nose cone having a central opening, 2) including a heat exchanger within the nose cone and routing a working fluid through the heat exchanger and 3) passing air into the central opening, and across the heat exchanger, and downstream of the heat exchanger exhausting the air through a rotating structure of the gas turbine engine.

In another embodiment according to any of the previous embodiments, the rotating structure includes at least one of blades of the rotor and the nose cone.

In another embodiment according to any of the previous embodiments, the rotor is an open rotor.

In another embodiment according to any of the previous embodiments, further includes the step of selectively opening and closing a door to allow air into the central opening, or block air from entering the central opening.

In another featured embodiment, a heat exchange system for an open rotor gas turbine engine, the heat exchange system includes a heat exchanger positioned within a nose cone of the open rotor gas turbine engine. The heat exchanger includes an inlet for accepting a working fluid and an outlet for exhausting the working fluid. A central opening is in a central portion of the nose cone to deliver cooling air across the heat exchanger. A duct downstream of the heat exchanger directs the cooling air radially to at least one rotating opening in a rotating structure such that the cooling air can move radially outward through the rotating structure and be directed into a propulsion airflow path.

In another embodiment according to any of the previous embodiments, the rotating structure includes the nose cone and a plurality of blades.

In another embodiment according to any of the previous embodiments, the at least one rotating opening includes at least one opening in a blade of the plurality of blades.

In another embodiment according to any of the previous embodiments, the plurality of blades rotate in a first direction, and the blade has a pressure side and a suction side and the at least one opening in the blade extends through the suction side such that it directs air generally in a direction opposite to the first direction.

In another embodiment according to any of the previous embodiments, further includes a door operable to selectively block airflow into the central opening in a closed position, or allow airflow into the central opening in an open position.

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1A shows an example gas turbine engine including a cooling structure.

FIG. 1B shows an airfoil of a rotor blade such as from the FIG. 1A engine.

FIG. 1C shows a second gas turbine engine cooling structure embodiment.

FIG. 1D shows a third gas turbine engine cooling structure embodiment.

FIG. 2A shows a first heat exchanger arrangement.

FIG. 2B shows a second heat exchanger arrangement.

FIG. 2C shows a third heat exchanger arrangement.

FIG. 2D shows a fourth heat exchanger arrangement.

FIG. 2E shows a fifth heat exchanger arrangement.

FIG. 2F shows a sixth heat exchanger arrangement.

FIG. 2G shows a seventh heat exchanger arrangement.

FIG. 2H shows an eighth heat exchanger arrangement.

### DETAILED DESCRIPTION

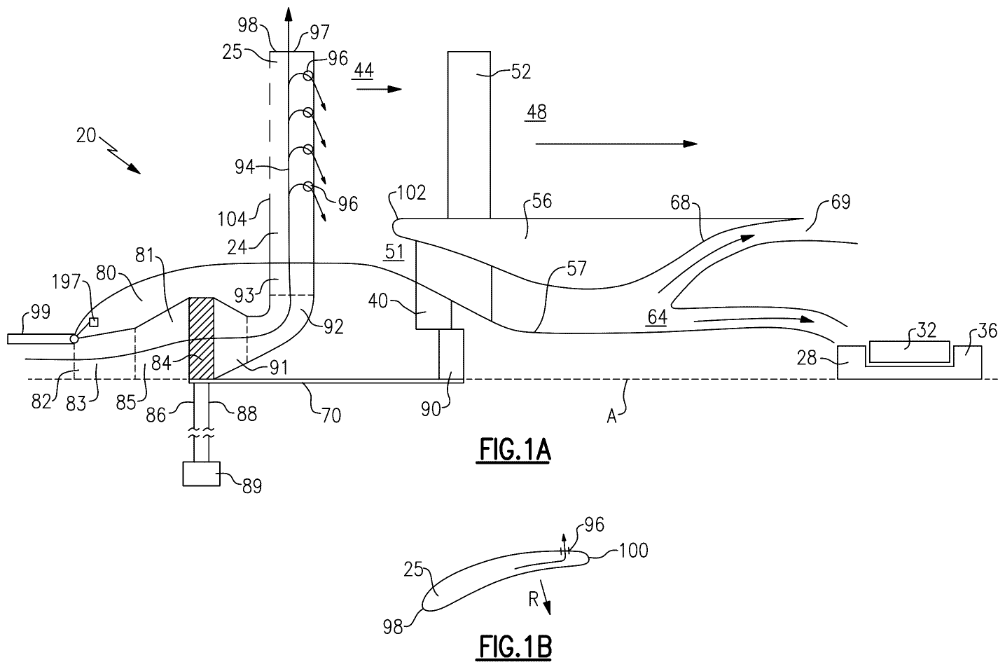

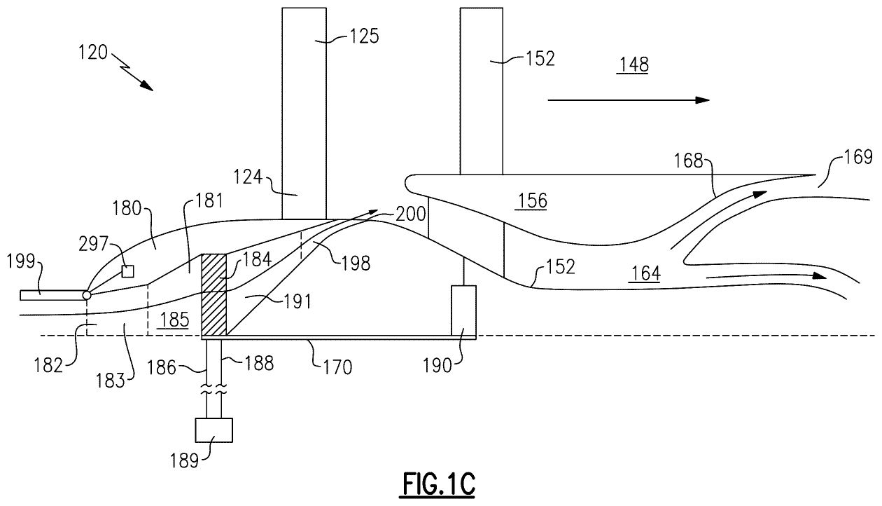

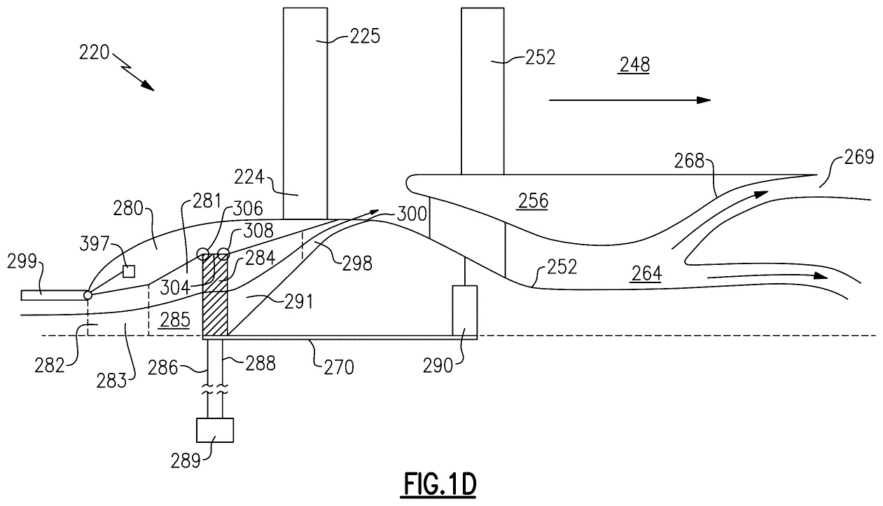

FIG. 1A schematically illustrates portions of a turbo prop or open-rotor gas turbine engine 20 for rotation about an engine central longitudinal axis A. The gas turbine engine 20 generally incorporates an open rotor propulsor or rotor 24. Notably, as would be appreciated by a person of ordinary skill in the art having the benefit of this disclosure, an open rotor gas turbine engine does not include a fan case or a bypass duct outward of rotor 24.

An open rotor propulsor is defined for purposes of this application as an array of propeller blades that has no housing radially outward of a plurality of blades 25 in the array. The use of such a design allows the blades 25 outer diameter to increase significantly, with an associated reduction in propulsor pressure ratio across the blades 25. Further, such engines can be adapted to more radical swept-blade wing shapes. These benefits would become difficult to achieve with a fan having an outer fan case.

The rotor 24 is connected to a geared architecture 40, shown schematically, to drive the rotor 24 at a lower speed than the speed of a fan drive turbine. In other examples, the rotor 24 can be a direct drive rotor (e.g. without the geared architecture 40), such as direct drive from a power turbine.

A compressor section 28, combustor 32 and turbine section 36 are all shown schematically. As known, each of the compressor section and turbine section may include two distinct rotors. A lower speed compressor rotor is driven by a low speed turbine and may be connected to drive the geared architecture 40 to in turn drive the rotor 24. The details of the drive connections may be as known. As known, there may also be a high pressure compressor and turbine.

The rotor 24 may drive ambient air 44 in a downstream direction along a propulsion flow path 48 and also into an inner flow path 51. Air exiting the rotor 24 may pass along swirl recovery vanes (SRVs) 52 to generate propulsion thrust. Although not illustrated, the SRVs 52 have an airfoil shape to direct the air moving downstream (see FIG. 1B, described below). The air entering the inner flow path flows inboard of a splitter structure composed of the outer core panel 56 and an inner wall 57. The air in the inner flow path then divides into a core flowpath 64 for compression via compressor 28 and into an optional auxiliary flowpath 68 ultimately leading to an exit 69 for additional propulsion thrust. This auxiliary flowpath may be used for a variety of purposes, including additional cooling capability.

A static gear housing 90 is shown for the geared architecture 40.

As mentioned above, it may be a challenge to obtain cooling air to cool engine systems, such as an environmental control system as well as other air and lubrication systems. In turbofan architectures, the fan stream bypass air may be used as a cooling source, such as with heat exchangers mounted in the bypass duct.

However, the supply of cooling air is much more challenging with an open rotor design as there is effectively no working static pressure due to the absence of an outer fan case. In addition, the available dynamic pressure is small due to the lower Fan Pressure Ratios (FPR's) of open-rotor designs.

To address these challenges with an open rotor design, the engine 20 illustrated in FIG. 1A uses a ram air scoop to feed a stationary heat exchanger 84 inside a rotating nose cone 80. The arrangement can be used to provide cooling whenever the aircraft is in flight, however, it is most effective at conditions typical at high altitude flight. There is an opening 82 in the center of nose cone or spinner 80 to allow ambient air into the interior chamber 81 of the nose cone 80. The opening 82 may be circular, rectangular, ovular, or any other shape. Regardless of the actual shape, the opening functions as a ram scoop and funnels air into the system. In some embodiments the nose cone 80 may be configured with a door 99, shown schematically, that is adjustable between a closed position (e.g., to reduce system drag) and an open position to allow air to flow through the opening 82 and into the interior chamber 81 for cooling. Actuator 197 for the door is show schematically. The air flows through a diffuser 83 and an inlet manifold 85. While the door 99 is shown at the front of the engine, it could be at a more downstream location along the air flow path.

As shown in FIG. 1B, the exit holes 96 are angled against the direction of rotation R of the blades 25. Because of this the ejected flow through these holes provides incremental power to help push the fan blades in the proper direction. In addition, the rotating blades act as a centrifugal pump on the spent heat exchanger air and consequentially increase its pressure as it travels outward, effectively increasing the system delta pressure. In addition to raising the spent heat exchanger air pressure as it travels radially outward through the fan blades 25, the centrifugal pump effect, together with the ram scoop and heat exchanger, all serve to increase its temperature. This heated air can be effectively used to provide a fan blade anti-icing benefit until it reaches the exit holes 96.

The heat exchanger 84 is static and secured as shown at 70 to gear housing 90. In one embodiment the entire heat exchanger 84 is static. However, in another embodiment (see FIG. 1D) the top boundary wall of the diffuser, inlet manifold and outlet manifold may all rotate with nose cone 80, with the heat exchanger always being static.

The heat exchanger may be a plate fin-type, a tube shell-type, or any other type of heat exchanger. As shown schematically, an engine system 89, which may be an ECS or other air system, a lubricant system, or other system that provides a working fluid through an inlet 88 to the heat exchanger 84. From the heat exchanger 84, the working fluid is cooled by the cooling air passing from the opening 82 across the heat exchanger 84. The working fluid then returns through line 86 to the system 89.

After the spent air passes thru the heat exchanger 84 it dumps into an exit manifold 91 which directs the flow into a duct 92 that turns the flow radial and passes it into an annular inlet manifold 93 and then finally into the fan blades 25. Notably, some, or all, of the fan blades 25 may be generally hollow. In addition to reducing the weight of the very large fan blades, being hollow also allows the warm air downstream of the heat exchanger 84 to travel radially outward via internal blade passages 24 and exit the fan blades 25 thru holes/slots 96 located at various radii on the airfoil suction side.

Because the holes 96 are angled opposite blade rotation and located on the suction sides of the airfoils, the local static pressure will be sub-ambient with the actual magnitude dependent on the local speed of the blade 25. As a result, the total system delta pressure is equivalent to HEXsys DP=Pup+DPinternal−Pdn=(Pamb+DPram)+DPfsb−(Pamb−DPsup)=DPram+DPfsb+DPsup where:
HEXsys DP 176048=Delta pressure across entire HEX system
Pup=System inlet pressure=Pamb+DPram
DPinternal=Fan rotational effect=DPfsb
Pdn=System dump pressure=Pamb−DPsup
Pamb=Ambient atmospheric pressure
DPram=RAM pressure effect (due to aircraft Mn)
DPfsb=Fan blade solid body pumping effect
DPsup=Hole orientation static pressure suppression effect.

The pressure driving the air would be different at each of the plurality of holes 96 illustrated. Some additional airflow may be directed outwardly of an opening 97 in a radially outer tip 98 of the fan blades 25 to increase system capacity. Note that this will provide additional anti-icing to the outer portion of the fan blade.

With this arrangement, the cooling airflow across the heat exchanger is generated by the aircraft itself and requires no other system. Especially at high altitudes, the inlet ambient temperatures may be very cold, e.g., −65° F. In addition, nose cones of typical commercial engines are empty such that no components would need to be relocated. Furthermore, similar to other fan hardware, nose cones also need to be anti-iced. The system described above can also provide that function, eliminating any need for a separate anti-icing feature.

An additional feature is that the holes 96 may be positioned in an outer portion of a radial span of the blades 25. Thus, as shown, a location 104 inward of the radially innermost opening 96 is still radially outward of an axially forwardmost point 102 of the housing 56. In this way, the relatively hot air is not directed into the inner flow path 51 in any great volume.

FIG. 1C shows another embodiment 120. Here, elements that are essentially the same as the elements in FIG. 1A are identified with an additional 100. Here, rather than exiting through the blades, there is an exit duct 191/198 leading to exit(s) 200 in an outer surface of the nose cone 180.

As shown, the FIG. 1C embodiment also includes a door 199 which may be opened and closed by an actuator 297.

This embodiment exhausts the spent heat exchanger air to a fan stream inner diameter just behind the fan blade, without the need for the air to first enter and internally traverse the fan blade. Although this configuration has a significantly lower working system pressure, it is also simpler to incorporate into an engine. The delta pressure here is defined by the following formula: HEXsys DP 176047=Pup−Pdn=(Pamb+Pram)−(Pamb)=Pram: where
HEXsys DP 176047=Delta pressure across entire HEX system
Pup=System inlet pressure=Pamb+D Pram
Pdn=System dump pressure=Pamb
Pamb=Ambient atmospheric pressure
DPram=RAM pressure effect (due to aircraft Mn)

Embodiment 220 is illustrated in FIG. 1D. Elements in FIG. 1D that are similar to the FIG. 1C embodiment are identified with an additional 100 added to them. Here, the top boundary wall of the diffuser, inlet manifold and outlet manifold may all rotate with nose cone 280 (e.g., nose cone 80, 180), with the heat exchanger always being static.

There are seals 306 and 308 between the rotating wall 304 and the heat exchanger 284.

Across FIGS. 1A, 1C and 1D it could be said that the spent air exits through a rotating structure, wherein the rotating structure is defined at least by the nose cone and blades.

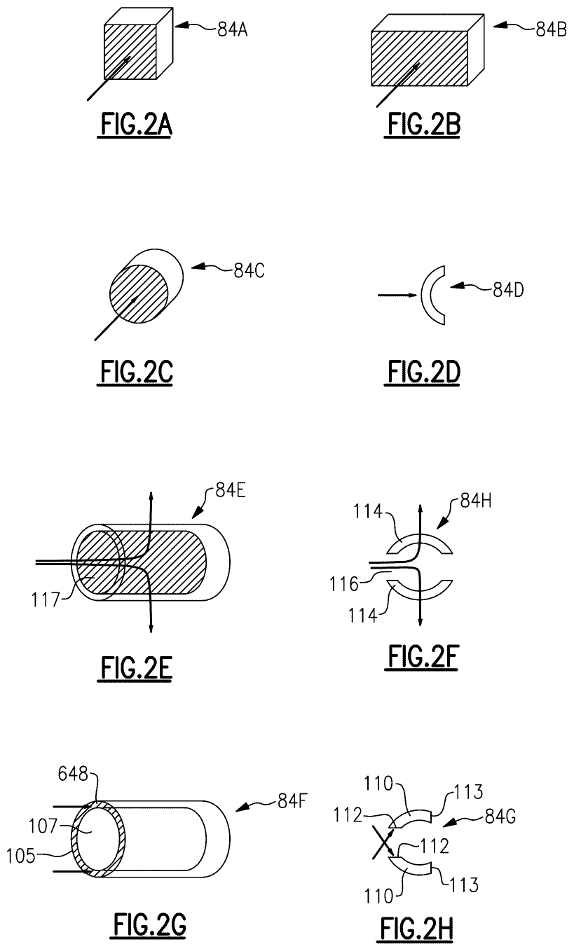

In the illustrative example of FIG. 2A, the heat exchanger 84A is square and includes a corresponding profile where ambient air of the chamber 81 is guided over the heat exchanger 84A.

In the illustrative example of FIG. 2B, the heat exchanger 84B is rectangular and includes a corresponding profile where ambient air from chamber 81 is guided over the heat exchanger 84B.

In the illustrative example of FIG. 2C, the heat exchanger 84C is circular and includes a corresponding profile where ambient air from the chamber 81 is guided over the heat exchanger 84C.

In the illustrative example of FIG. 2D, the heat exchanger 84D is arc-shaped and includes a corresponding profile where ambient air from the chamber 81 is guided over the heat exchanger 84D.

In the illustrative example of FIG. 2E, the heat exchanger 84E is cylindrical and includes a central channel 117 through which ambient air from the chamber 81 is received and passed through the heat exchanger 84E.

FIG. 2F shows a heat exchanger embodiment 84H. There are two arc portions 114. The air here passes into a central chamber 116, and then outwardly across the arc portions. Similar to the FIG. 2E embodiment, the air enters a central portion between the arc portions 114 and passes over them.

In the illustrative example of FIG. 2G, the heat exchanger 84F is cylindrical and includes a channel 105 through which ambient air from the chamber 81 is received and passed through the heat exchanger 84F. The channel 105 is generally defined between an inner cylinder 107 and an outer wall that surrounds the inner cylinder.

FIG. 2H shows an embodiment wherein the heat exchanger 84G includes two arc portions 110. Air is shown passing into an end 112 of the arc portions 110 to cool the working fluid. Here the air flows through the arc portions 110 from end 112 to ends 113.

Here, the air passes into a connecting duct 199, and outwardly through exits 200.

A gas turbine engine under this disclosure could be said to include an open rotor having blades without an outer housing (e.g. open rotor architecture), and rotating with a nose cone. The rotor, blades and nose cone are defined as a rotating structure. A static heat exchanger is positioned within the nose cone. There is a system for using a working fluid. An inlet from the system is connected to the heat exchanger and an outlet from the heat exchanger is connected back to the system. A central opening in a central portion of the nose cone delivers cooling air across the heat exchanger. A duct downstream of the heat exchanger directs the cooling air such that it can move radially outwardly through the rotating structure and can be directed into a propulsion airflow path.

A method of operating a gas turbine engine comprising the steps of 1) driving a gas turbine engine to rotate a rotor and a rotating nose cone, the nose cone having a central opening, 2) including a heat exchanger within the nose cone and routing a working fluid through the heat exchanger, and 3) passing air into the central opening, and across the heat exchanger, and downstream of the heat exchanger exhausting the air through rotating structure on the gas turbine engine.

Although embodiments of this disclosure have been shown, a worker of ordinary skill in this art would recognize that modifications would come within the scope of this disclosure. For that reason, the following claims should be studied to determine the true scope and content of this disclosure.

What is claimed is:

1. A gas turbine engine comprising:
a rotor having a plurality of blades without an outer housing, and rotating with a nose cone, wherein the rotor, plurality of blades and nose cone provide a rotating structure;
a static heat exchanger positioned within the nose cone and a system for using a working fluid, an inlet from the system connected to the heat exchanger and an outlet from the heat exchanger connected back to the system;
a central opening in a central portion of the nose cone to deliver cooling air across the heat exchanger; and
a duct downstream of the heat exchanger to direct the cooling air such that the cooling air can move radially outwardly through the rotating structure such that the cooling air can be directed into a propulsion airflow path.

2. The gas turbine engine as set forth in claim 1, wherein the central opening in the nose cone directs air into a diffuser.

3. The gas turbine engine as set forth in claim 1, further comprising an exit manifold downstream of the heat exchanger.

4. The gas turbine engine as set forth in claim 3, wherein downstream of the exit manifold the cooling air is connected into a connecting duct which turns it in a radially outward direction.

5. The gas turbine engine as set forth in claim 1, wherein the cooling air is directed radially outwardly into the plurality of blades, and outwardly through at least one blade opening.

6. The gas turbine engine as set forth in claim 5, further comprising an outer housing substantially surrounding at least a portion of a core engine, the outer housing having an axially forwardmost point, and the at least one blade opening is positioned to be radially outward of the axially forwardmost point.

7. The gas turbine engine as set forth in claim 5, wherein the plurality of blades rotate in a first direction, and each blade of the plurality of blades has a pressure side and a suction side and the at least one blade opening extends out of its respective blade through the suction side such that it directs air generally in a direction opposite to the first direction.

8. The gas turbine engine as set forth in claim 1, further comprising a door operable to selectively block airflow into the central opening in a closed position, or allow airflow into the central opening in an open position.

9. The gas turbine engine as set forth in claim 8, further comprising an actuator for the door.

10. The gas turbine engine as set forth in claim 1, wherein the heat exchanger is one of:
rectangular;
circular;
arc-shaped; or
cylindrical.

11. The gas turbine engine as set forth in claim 1, wherein the cooling air is directed radially outwardly through the nose cone.

12. A method of operating a gas turbine engine comprising the steps of:
1) driving a gas turbine engine to rotate a rotor and a nose cone, the nose cone having a central opening;
2) including a heat exchanger within the nose cone and routing a working fluid through the heat exchanger;
3) passing air into the central opening, and across the heat exchanger, and downstream of the heat exchanger exhausting the air through a rotating structure of the gas turbine engine.

13. The method as set forth in claim 12, wherein the rotating structure comprises at least one of blades of the rotor and the nose cone.

14. The method as set forth in claim 12, wherein the rotor is an open rotor.

15. The method as set forth in claim 12, further comprising the step of selectively opening and closing a door to allow air into the central opening, or block air from entering the central opening.

16. A heat exchange system for an open rotor gas turbine engine, the heat exchange system comprising:
a heat exchanger positioned within a nose cone of the open rotor gas turbine engine, the heat exchanger comprising an inlet for accepting a working fluid and an outlet for exhausting the working fluid;
a central opening in a central portion of the nose cone to deliver cooling air across the heat exchanger; and
a duct downstream of the heat exchanger to direct the cooling air radially to at least one rotating opening in a rotating structure such that the cooling air can move radially outward through the rotating structure and be directed into a propulsion airflow path.

17. The heat exchange system of claim 16, wherein the rotating structure includes the nose cone and a plurality of blades.

18. The heat exchange system of claim 17, wherein the at least one rotating opening comprises at least one opening in a blade of the plurality of blades.

19. The heat exchange system as set forth in claim 18, wherein the plurality of blades rotate in a first direction, and the blade has a pressure side and a suction side and the at least one opening in the blade extends through the suction side such that it directs air generally in a direction opposite to the first direction.

20. The heat exchange system as set forth in claim 16, further comprising a door operable to selectively block airflow into the central opening in a closed position, or allow airflow into the central opening in an open position.
